(19) United States
(12) Patent Application Publication
(10) Pub. No.: US 2007/0064293 A1
(43) Pub. Date: Mar. 22, 2007

(54) Method of adjusting the resonant frequency of an assembled torsional hinged device

(75) Inventors: Arthur Monroe Turner, Allen, TX (US); Andrew Steven Dewa, Plano, TX (US); John W. Orcutt, Richardson, TX (US); Mark W. Heaton, Irving, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/228,895

(22) Filed: Sep. 16, 2005

(51) Int. Cl. G02B 26/08

(52) U.S. Cl. 359/224; 359/198

(57) ABSTRACT

A method of adjusting the resonant frequency of a torsional hinged device such as a resonant mirror is disclosed. A material such as printer ink, epoxy, or solder balls is applied to the tips of the torsional hinged device to lower the frequency into a selected frequency range.

### TECHNICAL FIELD

The present invention relates to resonant torsional hinged mirrors and more particularly to the adjusting of the mirror resonant frequency after assembly of the mirror.

### BACKGROUND

In recent years, MEMS (Micro Electro Mechanical Systems) torsional hinged mirror structures have made significant strides as replacements for spinning polygon mirrors used as the engine for high speed printers and some types of display systems. Such torsional hinged mirror structures have certain advantages over the spinning polygon mirrors including lower cost and weight. However, every new technology has its own set of problems and using torsional hinged mirrors in precision applications is no exception.

One problem area is the manufacturing of such torsional hinged mirrors with a specific resonant frequency. The silicon components used to fabricate such torsional hinged mirrors may be manufactured from silicon wafers using semiconductor manufacturing process steps and methods. These silicon components are then combined with magnets to complete the assembly of many mirrors. Further, the resonant frequency of each mirror of the group of mirrors will likely be within a specified range of frequencies. Unfortunately, each of the assembled mirrors will not have the same resonant frequency because of variations in the silicon processing, silicon wafer thickness, and the exact mass distribution of the composite structure including the magnet size and density as well as variations in adhesive bond lines.

Therefore, it will be appreciated that a method of adjusting the resonant frequency of an assembled torsional hinged mirror could be advantageous.

### SUMMARY OF THE INVENTION

These and other problems are generally solved or circumvented and technical advantages are generally achieved by embodiments of the present invention, which provides a method of adjusting the resonant frequency of an assembled torsional hinged structure (such as a mirror). The method comprises the step of mounting the torsional hinged device to a support structure, and providing a drive mechanism proximate the mounted torsional hinged device to oscillate the torsional hinged device at its resonant frequency. The resonant frequency is monitored, and is then lowered to within a selected band of frequencies by selectively adding a material to a surface (preferably a back surface) of the device or mirror. According to one embodiment, the material is a material selected from the group consisting of printers ink, epoxy adhesive, solder balls, or any other material that will adhere the back side or edge of the mirror.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A and 1B are a side and bottom view, respectively, of a torsional hinged mirror that will benefit from the teachings of this invention;

FIGS. 2A and 2B represent magnetic drive mechanisms suitable for driving the torsional hinged mirror of FIGS. 1A and 1B; and

FIG. 3 is a schematic and block diagram illustrating a system incorporating the teachings of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

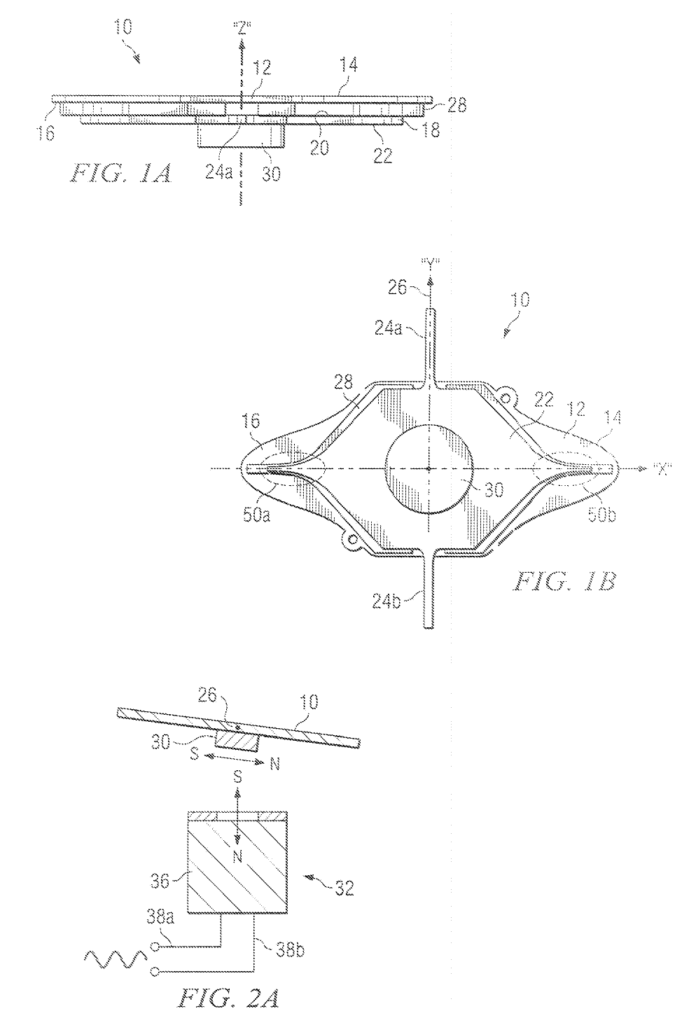

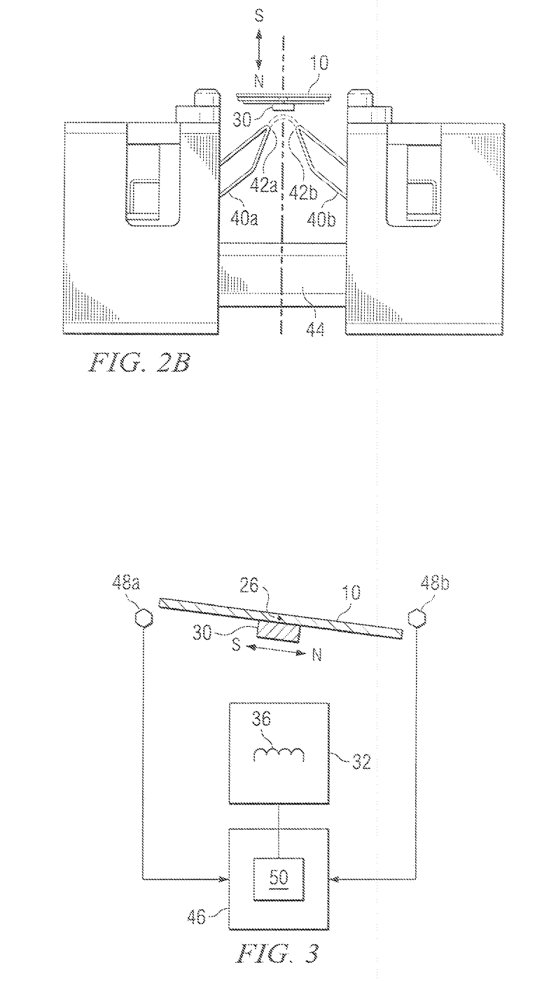

Referring now to FIGS. 1A and 1B, there is shown a side view and a bottom view of a multilayer torsional hinged resonant device incorporating the teachings of the present invention. As shown, the assembly 10 includes a front layer 12 having a top surface 14 (such as a reflective or mirror surface) and a back surface 16. Also included is a hinge layer 18 having a front portion 20 and a magnet side 22. Hinge layer 18 also defines a pair of torsional hinges 24a and 24b that are attached to a support structure (not shown) for supporting the torsional hinged device 10. As will be appreciated by those skilled in the art, device 10 oscillates on its torsional hinges 24a and 24b about pivot axis 26. Further as will be discussed later and for purposes of this invention, device 10 preferably oscillates about axis 26 substantially at its resonant frequency. The torsional hinged device illustrated in FIGS. 1A and 1B is also shown as including a truss layer 28 and a permanent magnet 30. Permanent magnet 30 will typically cooperate with an electromagnetic coil (to be discussed hereinafter) as a drive mechanism to provide the necessary force to initiate and maintain the device 10 oscillating at its resonant frequency. Although the illustrated drive mechanism is magnetic, it will be appreciated that other types of drive mechanisms such as inertial drive mechanisms are also suitable for use with this invention. Truss layer 28 is not always necessary, but is included as shown in FIGS. 1A and 1B to provide increased structural stiffness to improve dynamic deformation, reduce the mass of the mirror near the tips and position the center of the mass of the device to lie along pivot axis 26. It should also be appreciated that the front layer 14 and the truss layer 28 may comprise separate layers bonded together but preferably comprises a unitary structure etched from a single piece of silicon. Referring now to FIG. 2A, there is a diagram showing a simplified illustration of torsional hinged device 10 and one type of a magnetic drive mechanism. As shown, permanent magnet 30 is in place on the back side of device 10. Also shown is the magnetic drive mechanism 32 including a coil portion 36. Electrical leads 38a and 38b represent the coil leads that receive a drive signal, such as for example, a sinusoidal drive signal that has a frequency substantially equivalent to the resonant frequency of the resonant device 10. The sinusoidal drive signal passing through coil 36 continually changes the field N-S orientation above the coil portion 36. For example, FIG. 2A is shown with the field produced by the coil 36 having the South direction close to permanent magnet 30, and the North pole further away. However, as the sinusoidal drive signal continually changes from positive to negative and from negative to positive on input line 38, the field orientation from the coil 36 will also change from South to North and then back again from North to South at the same rate of the drive signal. Therefore, if the sinusoidal input signal to coil 36 is the same as the resonant frequency of the oscillating device or mirror, it will be appreciated that the mirror will oscillate at its resonant frequency with minimal drive power required. That is, as has been discussed, torsional hinged devices such as mirrors are particularly power efficient when operating at the resonant frequency of the device. It will also be appreciated by those skilled in the art that a continuous sinusoidal signal may not be required to maintain oscillation of the device 10 at its resonant frequency. One or more properly timed pulses may also be effective. FIG. 2B illustrates another magnetic drive mechanism that includes two arms 40a and 40b that generate a magnetic drive flux that extends between tips 42a and 42b and interacts with magnet 30. The magnetic drive flux is generated by a drive coil 44. The remainder of the drive mechanism of FIG. 2B is similar to that of FIG. 2A, except that the magnetization of the magnet is perpendicular to the silicon hinge layer or plate surface and the pole pieces 40a and 40b now produce a field substantially parallel to the surface of the device or mirror 10 and perpendicular to the torsional hinges. Other drive mechanisms, including inertia drive mechanisms, are also suitable for use with the present invention.

Referring now to FIG. 3, there is a simplified illustration of a torsional hinged device and drive system according to the teachings of the present invention. The elements of FIG. 3 that are the same or perform the same functions of FIGS. 2A and 2B have the same reference numbers. Also as shown in FIG. 3, there is included at least one sensor that monitors the angular position of the device 10 and provides a signal to computational circuitry 46. The system of FIG. 3 includes two sensors 48a and 48b. Computation circuit 46 also includes drive circuitry 50 that provides the appropriate drive signals (frequency and amplitude) to coil 36 of drive mechanism 32. Drive mechanism 32 interacts with permanent magnet 30 to initiate and maintain resonant oscillation of device 10.

As has been briefly discussed, device 10 preferably operates at resonance, and represents one of a multiplicity of torsional hinged devices (especially mirrors) preferably formed from a single crystal silicon wafer using semiconductor processing methods and steps. However, although the devices can be formed so that the resonant frequency falls within a range or band of frequencies, individual devices formed in the wafer will likely still have different resonant frequencies because of variations in fabrication steps and in assembling the device or mirror structure. For example, the thickness of the hinge plate or layer may vary as well as the width of the torsional hinge. Likewise, the thickness of the mirror or front layer and/or the truss layer may also vary in thickness because of variations in the etching process. If the device is a mirror, a reflective coating may be added to the front surface. The thickness of the deposited reflective coating may also slightly vary at different locations on the surface of the mirror and from mirror to mirror. The geometry and density of the permanent magnet may include variations that cause the mass moment of the assembled structure to vary. Also, if the device elements are bonded together, the thickness of the adhesive may vary over the bonded surface.

Studies indicate that these variations can produce frequency variations of ±3% or greater. Unfortunately, systems which use resonant scanning mirrors, such as laser printers or laser projection displays, have constraints on the operating frequency range of the resonant device that are more stringent than ±3%.

Furthermore, because these resonant devices are high-Q devices, the frequency of the drive signal must be very close to the resonant frequency of the device, or the sweep amplitude of the device may be significantly reduced. Consequently, since only a narrow range of resonant frequencies will be acceptable, the yield of the usable resonant devices will be low. If the yield is too low, there is little or no chance of using a resonant device in a commercial application.

The present invention provides a simple but elegant solution to this problem. More specifically referring to FIGS. 1A, 1B, and 3, according to the invention, the assembled device is oscillated at its resonant frequency as measured and determined by the sensors 48a and 48b and computation circuit 46 shown in FIG. 3. Also, to aid in understanding the invention, FIGS. 1A and 1B include the “X”, “Y”, and “Z” spatial axes. As shown, the “Y” axis corresponds to pivot axis 26 and the “X” axis lies on the same play as the “Y” axis but is perpendicular to and runs along the long dimension of the mirror device. The “Z” axis extends through the center of the magnet and the mirror structure and is, of course, perpendicular to both the “X” axis and the “Y” axis. If the device resonates at a frequency greater than that allowed by the specification limits, a small amount of material is applied to the back side of the mirror, such as shown by areas 50a and 50b on FIGS. 1A and 1B. This material will result in the resonant frequency of the device being reduced or lowered. Multiple applications or layers of the additional material have been found acceptable. Therefore, by adding the material in layers, the material may be sequentially added until the resonant frequency is lowered into the specified or allowed band of resonant frequencies. The material may be applied by touching with a pin or probe or any other suitable method. To maintain the device in proper balance, the material at areas 50a and 50b should be added in substantially equal portions on each side of the center line (“X” axis) that is perpendicular to the pivot axis 26 (axis “Y”). Likewise, to maintain mass balance along the axis perpendicular to the mirror surface (axis “Z”) material should also be added in substantially equal portions on each side of the axis.

Alternately, a fine coating can be applied by an atomizer or spray. Suitable materials include printer ink, epoxy, adhesive, solder balls, etc.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, composition of matter, methods and steps described in the specification. As one of ordinary skill in the art will readily appreciate from the disclosure of the present invention, processes, compositions of matter, methods, or steps, presently existing or later to be developed, that perform substantially the same function or achieve substantially the same result as the corresponding embodiments described herein may be utilized according to the present invention. Accordingly, the appended claims are intended to include within their scope such processes, compositions of matter, methods, or steps.

1. A method of adjusting the resonant frequency of a torsional hinged device comprising the steps of:
mounting the torsional hinged device to a support structure;
oscillating said torsional hinged device about a pivot axis at the resonant frequency of said mounted torsional hinged device;
determining the frequency of the resonant oscillations of said device; and
adding material to the resonant torsional hinged device to lower the resonant frequency of the device without changing a spring constant or Q of the device, wherein the step of adding material consists essentially of adding material to a back side of the torsional hinged device.

2. The method of claim 1 wherein said torsional hinged device is a silicon MEMS structure.

3. (canceled)

4. The method of claim 1 wherein said material is added in substantially equal portions to said device on each side of said pivot axis.

5. The method of claim 1 wherein said material is added in substantially equal portions to said device on each side of the centerline (“X” axis) of the device perpendicular to said pivot axis.

6. The method of claim 1 wherein said material is added in substantially equal portions along the axis perpendicular to a device surface (“Z” axis) to maintain mass balance along this axis.

7. The method of claim 1 wherein said material is selected from the group consisting of epoxy, printer ink, adhesive, and solder balls.

8. The method of claim 1 wherein said torsional hinged device is a torsional hinged mirror.

9. The method of claim 8 wherein said torsional hinged mirror includes first and second mirror tip areas spaced apart by equal distances on each side of said pivot axis and said added material is located at said first and second tip areas.

10. The method of claim 1 wherein said step of adding material comprises adding the material with more than one application.

11. A torsional hinged system having a resonant frequency comprising:
a support structure;
a torsional hinged device mounted to said support structure, said mounted torsional hinged device having a pivot axis and a resonant frequency;
a material added to said torsional hinged device to change the resonant frequency of said mounted torsional hinged device to be within a range of frequencies without changing a spring constant or Q of the device, wherein the material added consists essentially of adding material to a back side thereof;
sensors and a computational circuitry to determine the resonant frequency of said mounted torsional hinged device; and
a drive mechanism to drive said mounted torsional hinged device at its resonant frequency.

12. The system of claim 11 wherein said torsional hinged device is a torsional hinged mirror.

13. The system of claim 11 wherein said drive mechanism is a magnetic drive mechanism.

14. The system of claim 12 wherein said torsional hinged mirror defines a pair of spaced apart tips on each side of said pivot axis and wherein said added material is on said spaced apart tips.

15. The system of said claim 11 wherein said added material is selected from the group of materials consisting of epoxy, printer ink, adhesive, and solder balls.

16. The system of claim 11 wherein said added materials comprise at least two layers of added material.

17. The system of claim 11 wherein said torsional hinged device is a silicon MEMS structure.

18. The system of claim 11 wherein substantially equal portions of said material are on each side of the center line (“X” axis) of the device perpendicular to the pivot axis.

19. The system of claim 11 wherein substantially equal portions of said material are along the axis perpendicular to the device surface (“Z” axis).
